(19) United States
(12) Patent Application Publication
(10) Pub. No.: US 2026/0160302 A1
(43) Pub. Date: Jun. 11, 2026

(54) TORQUE LIMITER AND POWER TRANSMISSION DEVICE

(71) Applicant: EXEDY Corporation, Osaka (JP)

(72) Inventor: Hiroshi UEHARA, Osaka (JP)

(21) Appl. No.: 19/384,298

(22) Filed: Nov. 10, 2025

(30) Foreign Application Priority Data
Dec. 9, 2024 (JP) 2024-214436

(51) Int. Cl. F16D 7/02; F16D 65/00

(52) U.S. Cl. CPC F16D 7/025; F16D 65/0006

(57) ABSTRACT

It is intended to provide a torque limiter obtainable at a low cost. The present torque limiter includes a first side plate, a friction plate, a pressure plate, and an urging member. The first side plate includes an annular portion and a cylindrical portion. The annular portion extends in a circumferential direction. The cylindrical portion extends from an outer peripheral end of the annular portion in an axial direction. The friction plate is disposed to be rotatable relative to the first side plate. The pressure plate holds the friction plate in cooperation with the first side plate, with the friction plate interposed therebetween. The urging member urges the pressure plate toward the first side plate in the axial direction.

### CROSS-REFERENCE TO RELATED APPLICATIONS

This application is based on and claims the priority benefit of Japanese application No. 2024-214436 filed on Dec. 9, 2024, the contents of which are incorporated herein by reference.

### TECHNICAL FIELD

The present invention relates to a torque limiter and a power transmission device.

### BACKGROUND

A power transmission device disclosed in Japan Laid-open Patent Application Publication No. 2024-030506 includes a flywheel, a torque limiter, and a damper unit. The flywheel includes an inertia ring. The torque limiter is attached to the inertia ring.

### BRIEF SUMMARY

It is an object of the present invention to provide a torque limiter obtainable at a low cost.

A torque limiter according to a first aspect includes a first side plate, a friction plate, a pressure plate, and an urging member. The first side plate includes an annular portion and a cylindrical portion. The annular portion extends in a circumferential direction. The cylindrical portion extends from an outer peripheral end of the annular portion in an axial direction. The friction plate is disposed to be rotatable relative to the first side plate. The pressure plate holds the friction plate in cooperation with the first side plate, with the friction plate interposed therebetween. The urging member urges the pressure plate toward the first side plate in the axial direction.

According to this configuration, the first side plate includes the cylindrical portion extending in the axial direction; hence, the cylindrical portion is enabled to function as at least a part of an inertia ring. Because of this, the inertia ring can be omitted at least in part. It should be noted that the inertia ring is generally formed by casting. The first side plate is generally formed by sheet metal processing or stamping of a metallic plate. Now, the first side plate, formed by sheet metal processing or stamping, is lower in cost than the inertia ring formed by casting. Because of this, the torque limiter is made obtainable at a low cost.

A torque limiter according to a second aspect relates to the torque limiter according to the first aspect and further includes an inertia member. The inertia member is disposed to overlap with the cylindrical portion as seen in a radial direction, while being disposed to overlap with the annular portion as seen in the axial direction.

A torque limiter according to a third aspect relates to the torque limiter according to the second aspect and is configured as follows. The inertia member includes a screw hole extending in the axial direction.

A torque limiter according to a fourth aspect relates to the torque limiter according to the second or third aspect and is configured as follows. The inertia member is made in shape of an annulus extending in the circumferential direction. The inertia member is larger in plate thickness than the first side plate.

A torque limiter according to a fifth aspect relates to the torque limiter according to any of the second to fourth aspects and is configured as follows. The inertia member is a nut with a thickness larger than a plate thickness of the first side plate.

A torque limiter according to a sixth aspect relates to the torque limiter according to any of the second to fifth aspects and is configured as follows. The annular portion includes a bulging portion bulging to a side identical to extension of the cylindrical portion. The inertia member is disposed radially between the cylindrical portion and the bulging portion.

A torque limiter according to a seventh aspect relates to the torque limiter according to any of the first to sixth aspects and further includes a second side plate. The friction plate, the pressure plate, and the urging member are disposed axially between the first and second side plates.

A power transmission device according to an eighth aspect includes the torque limiter recited in any of the first to seventh aspects and a damper unit. The damper unit includes a first rotary member, a second rotary member, and an elastic member. The first rotary member is configured to be rotated unitarily with the friction plate. The second rotary member is disposed to be rotatable relative to the first rotary member. The elastic member elastically couples the first and second rotary members therethrough to each other.

A power transmission device according to a ninth aspect relates to the power transmission device according to the eighth aspect and is configured as follows. The first rotary member includes an outer peripheral surface in contact with an inner peripheral surface of the cylindrical portion.

A power transmission device according to a tenth aspect relates to the power transmission device according to the ninth aspect and is configured as follows. The outer peripheral surface of the first rotary member includes a contact portion and a non-contact portion. The contact portion extends in a circular-arc shape as seen in the axial direction. The contact portion is in contact with the inner peripheral surface of the cylindrical portion. The non-contact portion extends straight as seen in the axial direction. The non-contact portion is not in contact with the inner peripheral surface of the cylindrical portion.

A power transmission device according to an eleventh aspect relates to the power transmission device according to any of the eighth to tenth aspects and further includes a drive plate. The drive plate is configured to receive a torque outputted from a prime mover. The first side plate is configured to be rotated unitarily with the drive plate.

A power transmission device according to a twelfth aspect relates to the power transmission device according to the eleventh aspect and is configured such that the cylindrical portion extends from the outer peripheral end of the annular portion in the axial direction so as to separate from the drive plate.

A power transmission device according to a thirteenth aspect relates to the power transmission device according to the eleventh aspect and is configured such that the cylindrical portion extends from the outer peripheral end of the annular portion toward the drive plate in the axial direction.

Overall, according to the present invention, a torque limiter is made obtainable at a low cost.

### BRIEF DESCRIPTION OF THE DRAWINGS

FIG. 1 is a front view of a power transmission device.

FIG. 2 is a cross-sectional view of the power transmission device taken along line II-II in FIG. 1.

FIG. 3 is an enlarged cross-sectional view of the power transmission device.

FIG. 4 is a front view of a power transmission device according to a modification.

FIG. 5 is a cross-sectional view of the power transmission device taken along line V-V in FIG. 4.

FIG. 6 is a cross-sectional view of a power transmission device according to another modification.

FIG. 7 is a cross-sectional view of a power transmission device according to yet another modification.

### DETAILED DESCRIPTION

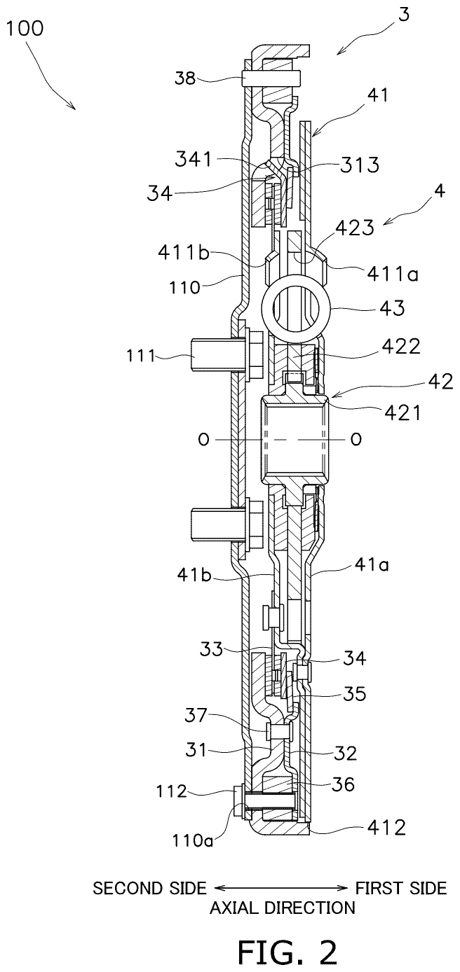

A torque limiter 3 and a power transmission device 100 according to the present preferred embodiment will be hereinafter explained with reference to drawings. It should be noted that in the following explanation, the term “axial direction” refers to an extending direction of a rotational axis O for both the torque limiter 3 and the power transmission device 100. On the other hand, the term “circumferential direction” refers to a circumferential direction of an imaginary circle about the rotational axis O, whereas the term “radial direction” refers to a radial direction of the imaginary circle about the rotational axis O. Additionally, the term “first side in the axial direction” means the right side in FIG. 2, whereas the term “second side in the axial direction” means the left side in FIG. 2.

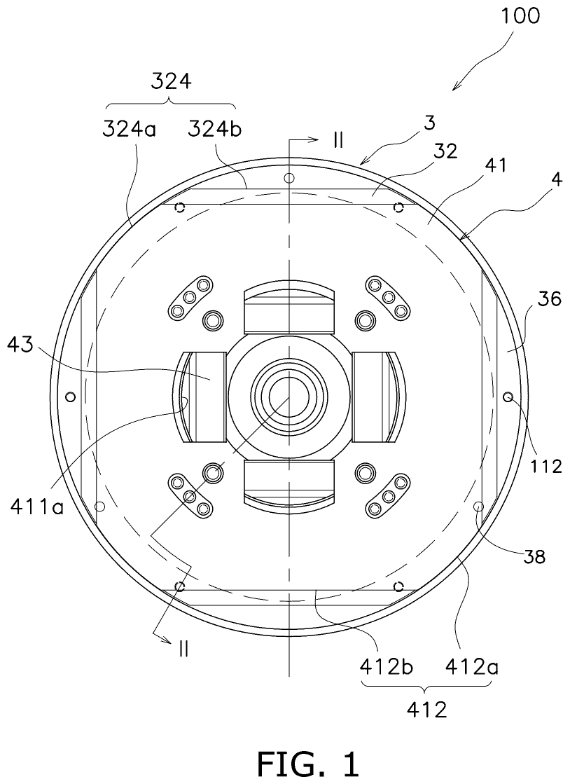

FIG. 1 is a front view of the power transmission device 100, whereas FIG. 2 is a cross-sectional view of the power transmission device 100 taken along line II-II in FIG. 1. As shown in FIGS. 1 and 2, the power transmission device 100 includes a drive plate 110, the torque limiter 3, and a damper unit 4. The drive plate 110 and the torque limiter 3 are configured to be rotated unitarily with each other. The torque limiter 3 and the damper unit 4, albeit rotatable relative to each other, are rotated unitarily with each other in most circumstances. When a torque transmitted to the power transmission device 100 exceeds a predetermined value, the torque limiter 3 and the damper unit 4 are rotated relative to each other.

The power transmission device 100 is installed between a prime mover (omitted in illustration) and an output-side member (omitted in illustration). It should be noted that the prime mover refers to, for instance, an internal combustion engine. On the other hand, the output-side member refers to, for instance, an electric motor, a transmission, or so forth. The internal combustion engine is disposed on the second side (the left side in FIG. 2) of the power transmission device 100 in the axial direction, whereas the output-side member is disposed on the first side (the right side in FIG. 2) of the power transmission device 100 in the axial direction. The power transmission device 100 is configured to limit a torque transmitted between the internal combustion engine and the output-side member and attenuate fluctuations in torque.

### Drive Plate

The drive plate 110 is configured to receive a torque outputted from the prime mover. Specifically, the drive plate 110 is attached to, for instance, a crankshaft (omitted in illustration) by a plurality of bolts 111. The drive plate 110 includes a plurality of through holes 110a. The through holes 110a are disposed at intervals in the circumferential direction. The drive plate 110 has a disc shape.

### Damper Unit

The damper unit 4 is attached to the torque limiter 3. The damper unit 4 is configured to attenuate fluctuations in rotation. The damper unit 4 includes a first rotary member 41, a second rotary member 42, and a plurality of elastic members 43.

### First Rotary Member

The first rotary member 41 is rotated unitarily with a friction plate 33 of the torque limiter 3 (to be described). The first rotary member 41 includes a first plate 41a and a second plate 41b. Each of the first and second plates 41a and 41b is an annular member including a center hole. The first and second plates 41a and 41b are rotated unitarily with each other. Moreover, the first and second plates 41a and 41b are axially immovable relative to each other.

The first and second plates 41a and 41b are disposed away from each other at an interval in the axial direction. The second plate 41b is disposed on the second side of the first plate 41a in the axial direction.

The first plate 41a includes a plurality of window portions 411a, while the second plate 41b includes a plurality of window portions 411b. It should be noted that in the present preferred embodiment, the first plate 41a includes four window portions 411a, while the second plate 41b includes four window portions 411b; however, the window portions 411a, 411b are not limited in number to this.

Not only the window portions 411a but also the window portions 411b are disposed away from each other at intervals in the circumferential direction. Not only the window portions 411a but also the window portions 411b are configured to accommodate the elastic members 43, respectively.

The first rotary member 41 is in contact at an outer peripheral surface 412 thereof with the inner peripheral surface of a cylindrical portion 312 (to be described). It should be noted that the outer peripheral surface 412 of the first rotary member 41 is composed of at least one of the outer peripheral surfaces of the first and second plates 41a and 41b. The outer peripheral surface 412 of the first rotary member 41 includes a plurality of contact portions 412a and a plurality of non-contact portions 412b. It should be noted that in the present preferred embodiment, the outer peripheral surface 412 of the first rotary member 41 includes four contact portions 412a and four non-contact portions 412b.

Each contact portion 412a extends in a circular-arc shape as seen in the axial direction. Each contact portion 412a is in contact with the inner peripheral surface of the cylindrical portion 312. Each non-contact portion 412b extends straight as seen in the axial direction. Each non-contact portion 412b is not in contact with the inner peripheral surface of the cylindrical portion 312.

The outer peripheral edge of the first rotary member 41 is disposed radially outside that of the friction plate 33. The first rotary member 41 overlaps at an outer peripheral part thereof with a plurality of fastening members 37 (to be described) as seen in the axial direction. Additionally, the first rotary member 41 overlaps at the outer peripheral part thereof with an inertia member 36 (to be described) as seen in the axial direction. The outer peripheral part of the first rotary member 41 is disposed on the first side of the torque limiter 3 in the axial direction.

### Second Rotary Member

The second rotary member 42 is configured to transmit the torque, inputted thereto from the first rotary member 41, to the output-side member. The second rotary member 42 is disposed axially between the first and second plates 41a and 41b. The second rotary member 42 is disposed to be rotatable relative to the first and second plates 41a and 41b.

The second rotary member 42 includes a hub 421 and a flange plate 422. The hub 421 and the flange plate 422 are separated as different members but may be integrated as a single member.

The hub 421 has a tubular shape and extends in the axial direction. The hub 421 is disposed in the center hole of the first plate 41a and that of the second plate 41b. The hub 421 is provided with a spline hole, extending in the axial direction, in an inner peripheral part thereof. The spline hole enables an input shaft of the output-side member to be spline-coupled thereto.

The flange plate 422 radially extends from the outer peripheral surface of the hub 421. The flange plate 422 has an annular shape. The flange plate 422 is disposed to be rotatable relative to the first and second plates 41a and 41b. The flange plate 422 is disposed axially between the first and second plates 41a and 41b.

The flange plate 422 includes a plurality of accommodation holes 423. It should be noted that in the present preferred embodiment, the flange plate 422 includes four accommodation holes 423; however, the accommodation holes 423 are not limited in number to this. The accommodation holes 423 are disposed away from each other at intervals in the circumferential direction. The accommodation holes 423 are configured to accommodate the elastic members 43, respectively. The accommodation holes 423 are disposed to overlap with not only the window portions 411a but also the window portions 411b, respectively, as seen in the axial direction.

### Elastic Members

The elastic members 43 are configured to elastically couple the first and second rotary members 41 and 42 therethrough to each other in a rotational direction. The elastic members 43 are, for instance, coil springs.

The elastic members 43 are accommodated in the accommodation holes 423 of the second rotary member 42, respectively. Notably, the elastic members 43 are accommodated in not only the window portions 411a of the first plate 41a but also the window portions 411b of the second plate 41b, respectively.

### Torque Limiter

The torque limiter 3 is disposed to be rotatable about the rotational axis O. The torque limiter 3 is disposed on the first side of the drive plate 110 in the axial direction. The torque limiter 3 has an annular shape. The torque limiter 3 is configured to be attached to the drive plate 110.

The torque limiter 3 is configured to limit the torque transmitted between the drive plate 110 and the damper unit 4. In other words, the torque limiter 3 is configured to restrict transmission of the torque in the power transmission device 100 when the torque is greater than or equal to the predetermined value.

The torque limiter 3 includes a first side plate 31, a second side plate 32, the friction plate 33, a pressure plate 34, an urging member 35, and the inertia member 36.

### First Side Plate

The first side plate 31 is disposed on the first side of the drive plate 110 in the axial direction. The first side plate 31 is attached to the drive plate 110. Specifically, the first side plate 31 includes a plurality of through holes 310. The through holes 310 are disposed at intervals in the circumferential direction. Each through hole 310 opens to the second side in the axial direction. The through holes 310 are disposed to communicate with the through holes 110a of the drive plate 110 in a one-to-one correspondence.

A plurality of bolts 112 fasten the drive plate 110, the first side plate 31, and the inertia member 36 therethrough to each other. The bolts 112 penetrate not only the through holes 110a of the drive plate 110 but also the through holes 310 of the first side plate 31, respectively. The first side plate 31 is rotated unitarily with the drive plate 110. The first side plate 31 has an annular shape. The first side plate 31 is larger in plate thickness than the drive plate 110.

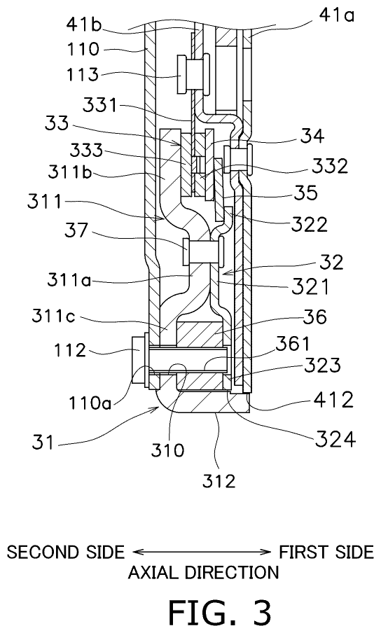

FIG. 3 is an enlarged cross-sectional view of the power transmission device 100. As shown in FIG. 3, the first side plate 31 includes an annular portion 311 and the cylindrical portion 312. The annular portion 311 and the cylindrical portion 312 are integrated as a single member.

The annular portion 311 is made in the shape of an annulus extending in the circumferential direction. The annular portion 311 includes a first bulging portion 311a, a first inner peripheral portion 311b, and a first outer peripheral portion 311c. The first bulging portion 311a bulges in the axial direction. The first bulging portion 311a bulges to a side identical to an extension of the cylindrical portion 312. In other words, the first bulging portion 311a bulges to the first side in the axial direction. The first bulging portion 311a bulges further to the first side in the axial direction than the other part of the annular portion 311. The first bulging portion 311a extends in the circumferential direction.

The first inner peripheral portion 311b is disposed radially inside the first bulging portion 311a. The first inner peripheral portion 311b is in contact with the friction plate 33.

The first outer peripheral portion 311c is disposed radially outside the first bulging portion 311a. The first outer peripheral portion 311c is in contact with the inertia member 36. Additionally, the first outer peripheral portion 311c is in contact with the drive plate 110. In other words, the first outer peripheral portion 311c is sandwiched between the drive plate 110 and the inertia member 36.

The cylindrical portion 312 extends from the outer peripheral end of the annular portion 311 in the axial direction. More specifically, the cylindrical portion 312 extends from the outer peripheral end of the annular portion 311 to the first side in the axial direction. In other words, the cylindrical portion 312 extends from the outer peripheral end of the annular portion 311 in the axial direction so as to separate from the drive plate 110. It should be noted that the cylindrical portion 312 can be formed by bending an outer peripheral part of the first side plate 31 in the axial direction. The first side plate 31 can be formed by sheet metal processing or stamping.

### Second Side Plate

The second side plate 32 is disposed on the first side of the first side plate 31 in the axial direction. The friction plate 33, the pressure plate 34, and the urging member 35 are disposed axially between the first and second side plates 31 and 32. The second side plate 32 is smaller in plate thickness than the first side plate 31.

The second side plate 32 is configured to be rotated unitarily with the first side plate 31. The second side plate 32 is fastened to the first side plate 31 by the plural fastening members 37. The fastening members 37 are disposed at intervals in the circumferential direction. The fastening members 37 are, for instance, rivets.

The second side plate 32 includes a second bulging portion 321, a second inner peripheral portion 322, and a second outer peripheral portion 323. The second bulging portion 321 bulges in the axial direction. The second bulging portion 321 bulges to a side opposite to bulging of the first bulging portion 311a. Specifically, the second bulging portion 321 bulges to the second side in the axial direction. In other words, the second bulging portion 321 bulges toward the first bulging portion 311a.

The second bulging portion 321 extends in the circumferential direction. The second bulging portion 321 is in contact with the first bulging portion 311a in the axial direction. The fastening members 37 fasten the first and second bulging portions 311a and 321 therethrough to each other.

The second inner peripheral portion 322 is disposed radially inside the second bulging portion 321. The second inner peripheral portion 322 supports the urging member 35. The second inner peripheral portion 322 is disposed away from the first inner peripheral portion 311b at an interval in the axial direction. The friction plate 33, the pressure plate 34, and the urging member 35 are disposed axially between the first and second inner peripheral portions 311b and 322.

The second outer peripheral portion 323 is disposed radially outside the second bulging portion 321. The second outer peripheral portion 323 is disposed away from the first outer peripheral portion 311c at an interval in the axial direction. The inertia member 36 is disposed axially between the first and second outer peripheral portions 311c and 323. The second outer peripheral portion 323 is in contact with the inertia member 36.

The second side plate 32 is in contact at an outer peripheral surface 324 with the inner peripheral surface of the cylindrical portion 312. As shown in FIG. 1, the outer peripheral surface 324 of the second side plate 32 includes a plurality of contact portions 324a and a plurality of non-contact portions 324b. It should be noted that in the present preferred embodiment, the outer peripheral surface 324 of the second side plate 32 include four contact portions 324a and four non-contact portions 324b.

Each contact portion 324a extends in a circular-arc shape as seen in the axial direction. Each contact portion 324a is in contact with the inner peripheral surface of the cylindrical portion 312. Each non-contact portion 324b extends straight as seen in the axial direction. Each non-contact portion 324b is not in contact with the inner peripheral surface of the cylindrical portion 312.

### Friction Plate

As shown in FIGS. 2 and 3, the friction plate 33 is a plate made in the shape of an annulus extending in the circumferential direction. The friction plate 33 is disposed to be rotatable about the rotational axis O. The friction plate 33 is disposed to be rotatable relative to the first side plate 31.

The friction plate 33 is in contact with the first side plate 31 in the axial direction. In more detail, the friction plate 33 is in contact with the first inner peripheral portion 311b of the annular portion 311 in the axial direction. The friction plate 33 is configured to be engaged by friction with the first side plate 31.

The friction plate 33 is attached to the first rotary member 41. More specifically, the friction plate 33 is attached to the second plate 41b. For example, the friction plate 33 is attached to the second plate 41b by one or more fastening members 113. The friction plate 33 is rotated unitarily with the first rotary member 41. It should be noted that the friction plate 33 is provided as a discrete member separated from the second plate 41b; alternatively, the friction plate 33 may be integrated with the second plate 41b as a single member.

The friction plate 33 includes a plate body 331, a first friction material 332, and a second friction material 333. The plate body 331 is made in the shape of an annulus extending in the circumferential direction. The first friction material 332 is attached to the axially first side one of the surfaces of the plate body 331. The second friction material 333 is attached to the axially second side one of the surfaces of the plate body 331. The first and second friction materials 332 and 333 are rotated unitarily with the plate body 331. Each of the first and second friction materials 332 and 333 has an annular shape. The first and second friction materials 332 and 333 are attached to an outer peripheral part of the plate body 331.

### Pressure Plate

The pressure plate 34 has an annular shape. The pressure plate 34 is disposed axially between the urging member 35 and the friction plate 33. The pressure plate 34 holds the friction plate 33 in cooperation with the first side plate 31, with the friction plate 33 interposed therebetween. The pressure plate 34 is in contact with the first friction material 332, while the first side plate 31 is in contact with the second friction material 333.

The pressure plate 34 is configured to be rotated unitarily with the first side plate 31. It should be noted that the pressure plate 34 is axially movable with respect to the first side plate 31. Specifically, the pressure plate 34 includes a plurality of protruding portions 341 protruding radially outward (see FIG. 2). The protruding portions 341 are engaged with a plurality of engaging holes 313 provided in the first side plate 31, respectively, whereby the pressure plate 34 is rotated unitarily with the first side plate 31, while being axially movable with respect thereto.

### Urging Member

The urging member 35 is disposed axially between the second side plate 32 and the pressure plate 34. The urging member 35 urges the pressure plate 34 to the second side in the axial direction. In other words, the urging member 35 urges the pressure plate 34 toward the first side plate 31. Accordingly, the friction plate 33 is held by the pressure plate 34 and the first side plate 31, while being interposed therebetween. The urging member 35 is made in the shape of an annulus extending in the circumferential direction. The urging member 35 is, for instance, a disc spring. The urging member 35 is in contact at the outer peripheral end thereof with the second inner peripheral portion 322, while being in contact at the inner peripheral end thereof with the pressure plate 34.

### Inertia Member

The inertia member 36 is made in the shape of an annulus extending in the circumferential direction. The inertia member 36 is larger in plate thickness than the first side plate 31. It should be noted that the plate thickness of the inertia member 36 means the axial dimension thereof. The inertia member 36 is disposed on the first side of the first side plate 31 in the axial direction. The inertia member 36 includes a plurality of screw holes 361. Each screw hole 361 opens to the second side in the axial direction. It should be noted that in the present preferred embodiment, each screw hole 361 penetrates the inertia member 36 in the axial direction; hence, each screw hole 361 opens to the first side in the axial direction as well. The screw holes 361 are communicated with the through holes 310 on a one-to-one correspondence. The bolts 112 are screwed into the screw holes 361 of the inertia member 36, respectively. Accordingly, the torque limiter 3 is attached to the drive plate 110.

The inertia member 36 is configured to be rotated unitarily with the first side plate 31. Specifically, the inertia member 36 is attached to the first side plate 31 by a plurality of pins 38. The inertia member 36 is attached to the first side plate 31 by the plural bolts 112 as well.

The inertia member 36 overlaps with the cylindrical portion 312 as seen in the radial direction. In more detail, the outer peripheral surface of the inertia member 36 is opposed to the inner peripheral surface of the cylindrical portion 312. The inertia member 36 overlaps with the annular portion 311 as seen in the axial direction. In more detail, the inertia member 36 overlaps with the first outer peripheral portion 311c as seen in the axial direction. The inertia member 36 is opposed to the annular portion 311. It should be noted that another member may be interposed between the inertia member 36 and the annular portion 311.

The inertia member 36 overlaps with the second side plate 32 as seen in the axial direction. More specifically, the inertia member 36 overlaps with the second outer peripheral portion 323 as seen in the axial direction. The inertia member 36 is opposed to the second outer peripheral portion 323. It should be noted that another member may be interposed between the inertia member 36 and the second outer peripheral portion 323.

The inertia member 36 is sandwiched by the annular portion 311 of the first side plate 31 and the second side plate 32 in the axial direction. More specifically, the inertia member 36 is sandwiched by the first outer peripheral portion 311c and the second outer peripheral portion 323 in the axial direction.

The inertia member 36 is disposed radially outside the first bulging portion 311a. The inertia member 36 is disposed radially outside the second bulging portion 321. The inertia member 36 is disposed radially between the cylindrical portion 312 and the first bulging portion 311a. Additionally, the inertia member 36 is disposed radially between the cylindrical portion 312 and the second bulging portion 321. Thus, the inertia member 36 is disposed in a space defined by the cylindrical portion 312, the first outer peripheral portion 311c, the first bulging portion 311a, the second outer peripheral portion 323, and the second bulging portion 321.

### Modifications

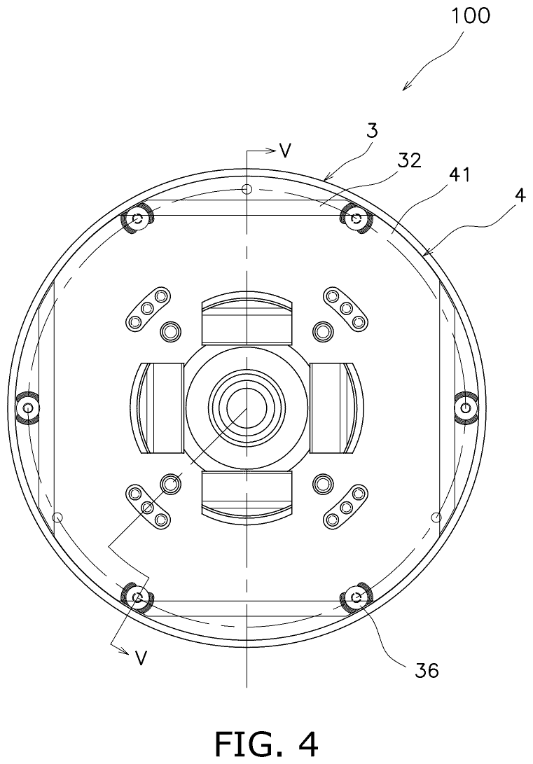

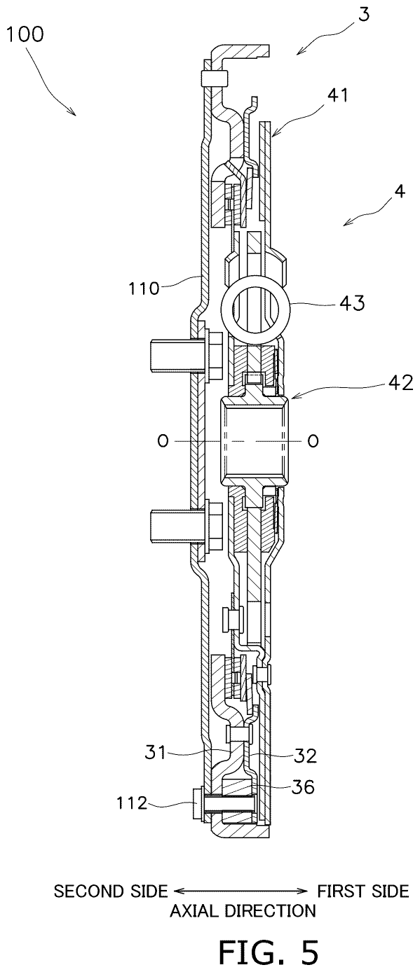

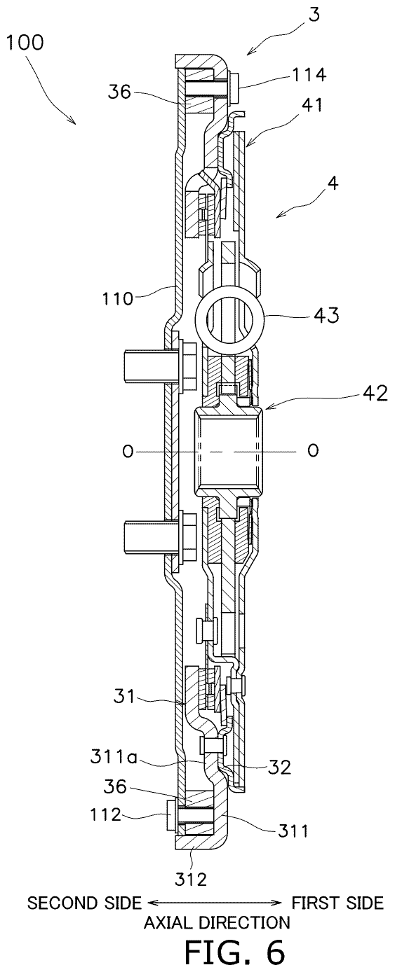

One preferred embodiment of the present invention has been explained above. However, the present invention is not limited to the above, and a variety of changes can be made without departing from the gist of the present invention. It should be noted that basically speaking, respective modifications to be described are applicable simultaneously.
(a) The inertia member 36 may not be made in the shape of an annulus. For example, as shown in FIGS. 4 and 5, the inertia member 36 may be composed of a plurality of nuts 36. The nuts 36 are disposed at intervals in the circumferential direction. Each nut 36 has a thickness larger than the plate thickness of the first side plate 31. It should be noted that FIG. 4 is a front view of a power transmission device in the present modification, whereas FIG. 5 is a cross-sectional view of the power transmission device taken along line V-V in FIG. 4.
(b) As shown in FIG. 6, the cylindrical portion 312 may extend from the outer peripheral end of the annular portion 311 to the second side in the axial direction. In other words, the cylindrical portion 312 may extend from the outer peripheral end of the annular portion 311 toward the drive plate 110 in the axial direction. In this case, the first bulging portion 311a bulges to the second side in the axial direction. In other words, the first bulging portion 311a bulges to a side identical to extension of the cylindrical portion 312.

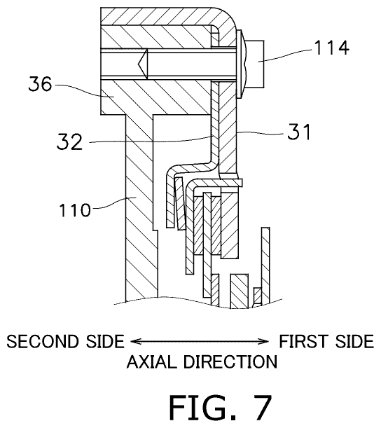

The inertia member 36 can be disposed on the second side of the first side plate 31 in the axial direction. The inertia member 36 is sandwiched by the drive plate 110 and the first side plate 31. In this case, the inertia member 36 is fixed to the first side plate 31 by one or more bolts 114. It should be noted that the bolts 112 fasten the drive plate 110 and the inertia member 36 therethrough to each other.
(c) In the preferred embodiment described above, the torque limiter 3 includes the inertia member 36; however, the torque limiter 3 may not include the inertia member 36.
(d) In the preferred embodiment described above, the inertia member 36 is provided as a discrete member separated from the drive plate 110; however, the inertia member 36 is not limited in configuration to this. For example, as shown in FIG. 7, the inertia member 36 may be integrated with the drive plate 110. Additionally, the second side plate 32 may be disposed on the second side of the first side plate 31 in the axial direction.

### LIST OF REFERENCE NUMERALS

3: Torque limiter, 31: First side plate, 311: Annular portion, 311a: First bulging portion, 312: Cylindrical portion, 32: Second side plate, 324: Outer peripheral surface, 324a: Contact portion, 324b: Non-contact portion, 33: Friction plate, 34: Pressure plate, 35: Urging member, 36: Inertia member, 361: Screw hole, 4: Damper unit, 41: First rotary member, 42: Second rotary member, 43: Elastic member, 100: Power transmission device, 110: Drive plate, 112: Bolt

What is claimed is:

1. A torque limiter comprising:
a first side plate including an annular portion and a cylindrical portion, the annular portion extending in a circumferential direction, the cylindrical portion extending from an outer peripheral end of the annular portion in an axial direction;
a friction plate disposed to be rotatable relative to the first side plate;
a pressure plate holding the friction plate in cooperation with the first side plate, with the friction plate interposed therebetween; and
an urging member urging the pressure plate toward the first side plate in the axial direction.

2. The torque limiter according to claim 1, further comprising:
an inertia member disposed to overlap with the cylindrical portion as seen in a radial direction, the inertia member disposed to overlap with the annular portion as seen in the axial direction.

3. The torque limiter according to claim 2, wherein the inertia member includes a screw hole extending in the axial direction.

4. The torque limiter according to claim 2, wherein
the inertia member is made in shape of an annulus extending in the circumferential direction, and
the inertia member is larger in plate thickness than the first side plate.

5. The torque limiter according to claim 2, wherein the inertia member is a nut with a thickness larger than a plate thickness of the first side plate.

6. The torque limiter according to claim 2, wherein
the annular portion includes a bulging portion bulging to a side identical to extension of the cylindrical portion, and
the inertia member is disposed radially between the cylindrical portion and the bulging portion.

7. The torque limiter according to claim 1, further comprising:
a second side plate, wherein
the friction plate, the pressure plate, and the urging member are disposed axially between the first and second side plates.

8. A power transmission device comprising:
the torque limiter of claim 1; and
a damper unit including a first rotary member, a second rotary member, and an elastic member, the first rotary member configured to be rotated unitarily with the friction plate, the second rotary member disposed to be rotatable relative to the first rotary member, the elastic member elastically coupling the first and second rotary members therethrough to each other.

9. The power transmission device according to claim 8, wherein the first rotary member includes an outer peripheral surface in contact with an inner peripheral surface of the cylindrical portion.

10. The power transmission device according to claim 9, wherein the outer peripheral surface of the first rotary member includes
a contact portion extending in a circular-arc shape as seen in the axial direction, the contact portion being in contact with the inner peripheral surface of the cylindrical portion, and
a non-contact portion extending straight as seen in the axial direction, the non-contact portion being not in contact with the inner peripheral surface of the cylindrical portion.

11. The power transmission device according to claim 8, further comprising:
a drive plate configured to receive a torque outputted from a prime mover, wherein
the first side plate is configured to be rotated unitarily with the drive plate.

12. The power transmission device according to claim 11, wherein the cylindrical portion extends from the outer peripheral end of the annular portion in the axial direction so as to separate from the drive plate.

13. The power transmission device according to claim 11, wherein the cylindrical portion extends from the outer peripheral end of the annular portion toward the drive plate in the axial direction.
